(19) United States
(12) Patent Application Publication
(10) Pub. No.: US 2007/0113071 A1
(43) Pub. Date: May 17, 2007

(54) Method for a secure data transmission

(75) Inventors: Andreas Lindinger, Floezlingen (DE); Michael Salm, Peterzell (DE)

Correspondence Address: SIEMENS SCHWEIZ AG;I-47, INTELLECTUAL PROPERTY, ALBISRIEDERSTRASSE 245, ZURICH, CH-8047, CH

(73) Assignee: SIEMENS AKTIENGESELLSCHAFT, Munich (DE)

(21) Appl. No.: 10/554,275

(22) PCT Filed: Jun. 2, 2005
(86) PCT No.: PCT/EP05/52530

§ 371 Date: Oct. 25, 2005

(30) Foreign Application Priority Data
Aug. 3, 2004 (DE) 10 2004 037 801.0

(51) Int. Cl. H04L 9/00

(52) U.S. Cl. 713/156

(57) ABSTRACT

The invention relates to a method for secure data transmission, particularly between a tachograph (51) in a commercial vehicle and memory cards (50), where a first subscriber (T1) has a memory (6, 22) with entries (31-35) comprising identifiers (4) and security certificates (Cert) from second subscribers (T2). Methods for secure data transmission are becoming increasingly important and are frequently associated with a high level of computation complexity. For this reason, the object of the invention is to reduce the computation time for this without security losses. It is proposed that the first subscriber (T1) fetch an identifier (4) from the second subscriber (T2) and compare it with stored identifiers (4). If the identifier (4) matches, a security certificate (Cert) associated with this identifier (4) is the basis for a subsequent data transmission, and if the identifier (4) does not match then security certificate verification is performed.

The invention relates to a method for secure data transmission between a first subscriber and second subscribers, particularly a tachograph in a commercial vehicle and memory cards having at least one respective data store, where the first subscriber has a memory which stores a particular number of entries, each comprising identifiers and associated security certificates from second subscribers with a detection time for the security certificate.

Methods for secure data transmission are becoming increasingly important and already exist in many diverse forms in the field of computer networks. Comparable in the wider sense with modern computer networks is also the interaction or the secure data transmission of a digital tachograph with a memory card on the basis of EC regulation 3821/85. To ensure that existing social rules and laws are observed at the workplace of the commercial vehicle, it is particularly important to increase protection against manipulation. For this reason, the most stringent standards are placed on the security of data transmission. To this end, a system of security certificates comprising various public and private keys has been developed which can be found in detail in the aforementioned regulation. Before a first subscriber or the tachograph can interchange data with a second subscriber or a memory card, there is a need for, inter alia, a very complex method of security certificate verification on both of the subscribers' parts. The extent of this process and the restricted opportunities for data processing in the small-format appliance make special precautions necessary so that the access times remain within a sensible framework with an acceptable cost outlay,

The invention is therefore based on the object of reducing the time, in particular, required for the security Certificate verifications for the subscribers involved in the data interchange without losing protection against manipulation.

The invention achieves the object by proposing a method of the type mentioned at the outset which involves the first subscriber fetching an identifier from the second subscriber, the first subscriber comparing this identifier with the identifiers stored in the memory, a matching identifier stored in the memory prompting the security certificate associated with this identifier to be the basis for a subsequent data transmission, and the detection time for the security certificate being updated to a current system time, no matching identifier stored in the memory prompting the first subscriber to perform security certificate verification with the second subscriber and, in the event of verification, storing an entry corresponding to the verified security certificate with the current detection time in the memory, with the entry with the oldest detection date being replaced by this new entry if the particular number of entries has already been reached.

A crucial advantage of the inventive method is the saving on the very time-consuming process of security certificate verification when the second subscriber is known to the first subscriber on account of a verification process which has already been carried out in the past. For reasons of memory space, particularly when the first subscriber is in the form of a tachograph and the second subscriber is in the form of a memory card, limitation of the number of entries comprising the security certificates and the detection time for the security certificates of other subscribers is limited. To optimize the first subscriber's “memory capability” for second subscribers to a very large number of second subscribers despite this limitation, the inventive method does not provide simple ring storage in chronological order of occurrence of the second subscribers, which means that the oldest entries are always overwritten by the newest entry, for example, if a memory-space-related maximum number of entries has already been reached. Instead, the content of the first subscriber's memory is first checked to determine whether there is already an entry with an identical identifier to that of the new subscriber which, if so, is updated only with regard to the detection date and possibly with regard to the sequence of the validity of the security certificate. In this way, provided that a number of different second subscribers which exceeds the particular number of memory entries has already been verified in the past, the first subscriber always knows the particular number of second subscribers. This allows the particular number, in line with the practices of a transport fleet, for example, to be matched to the number of different card holders who work there or who usually work with the commercial vehicle and thus allows optimum use of the memory in the first subscriber to be achieved. The access times remain advantageously short, since even when the first subscriber and the second subscriber are repeatedly cut off and connected only the entries which are associated with the identity of the first subscriber are ever altered or updated.

Advantageously, the subscribers, identifier transmitted for identification purposes is a public key from an RSA method (encryption and decryption method developed by Ronald L Rivest, Adi Schamir and Leonard Adleman) from the second subscriber. This public key can firstly be used for subsequent data transmission and is secondly unique.

In order to save computation complexity, one advantageous development provides for subsequent data transmission to be effected using symmetrical encryption, particularly a triple DES method, with verification of the security certificates being followed by both subscribers sending a random number in encrypted form to the other subscriber and both subscribers independently of one another each using the two random numbers to determine a common key for data transmission using the same algorithm. Essentially, the security of the asymmetrical encryption method is maintained in this context, since the session key for the symmetrical method can be generated only by the one which was previously able to use the asymmetrical method to communicate with the other subscriber or to decipher the reciprocally transmitted random number.

In line with the method based on the invention, an important position in terms of security against manipulation is adopted by the verification of the security certificates by the respective other subscriber, which is why this expediently involves the following n steps:

in a first step the second subscriber sends the first subscriber a first security certificate, which the second subscriber subjects to verification using a first public key and in so doing ascertains a second public key. If the verification results in authenticity of the transmitted security certificate then the first step is repeated (n-1) times using a further transmitted security certificate and the second public key ascertained in the previous step instead of the first public key, with a new second public key and a verification result always being obtained. This interleaved verification may expediently be repeated 3(=n) times, which results in a very high level of security against manipulation.

The invention is subsequently described in more detail for the purpose of clarification using a special exemplary embodiment with reference to drawings, in which:

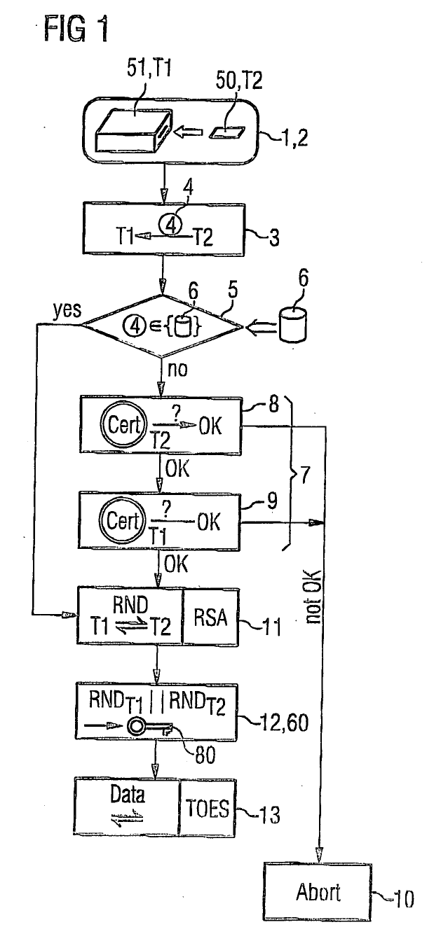

FIG. 1 shows a schematic illustration of the inventive method in the form of a flowchart,

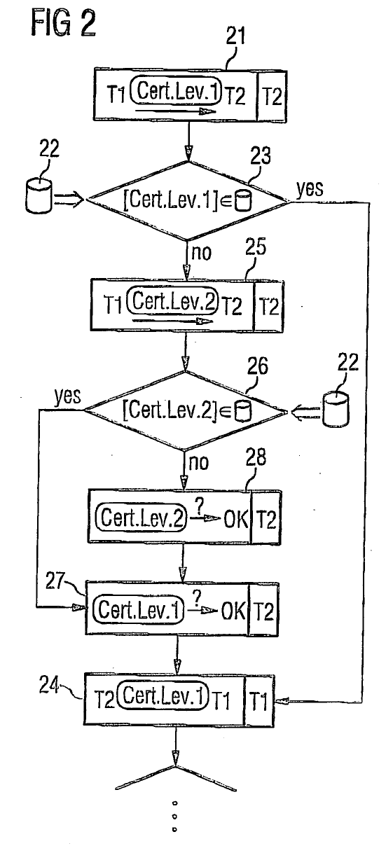

FIG. 2 shows a flowchart of the process of security certificate verification,

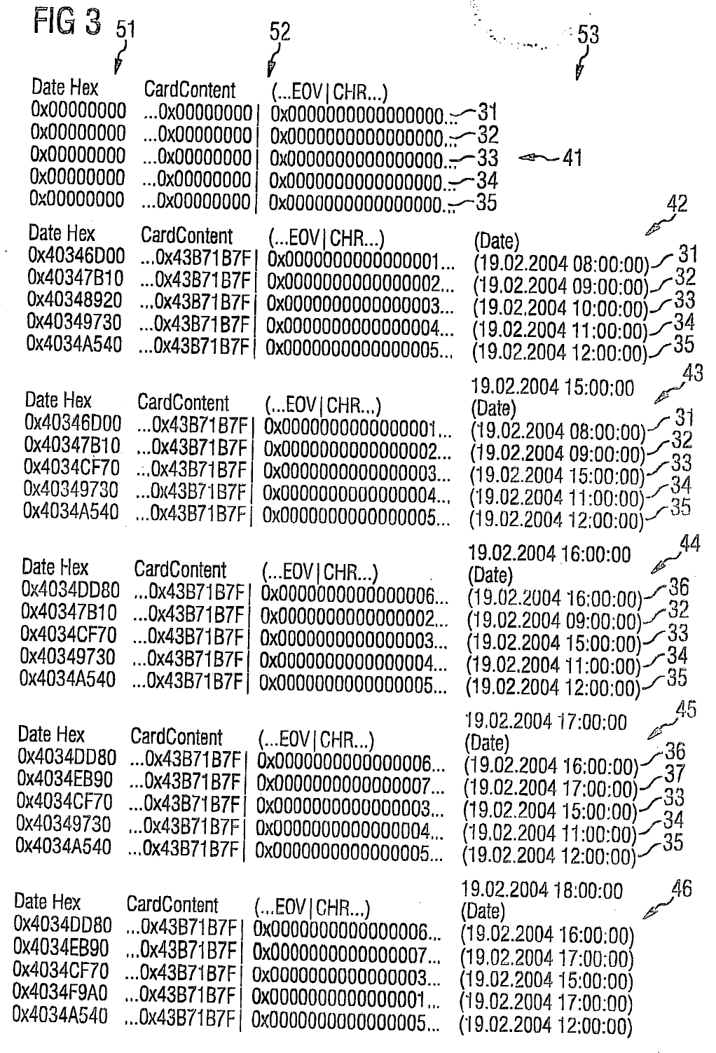

FIG. 3 shows entries for known second subscribers in a memory in a first subscriber.

The flowchart in FIG. 1 shows fundamental steps in the flow of a method based on the invention by way of example using data interchange between a digital tachograph 51 and a memory card 50.

The initiating event 1 is when the tachograph 51 picks up 2 the memory card 50. When the memory card 50, which is a second subscriber T2 within the meaning of the invention, is picked up 2, the tachograph, which is a first subscriber T1 within the meaning of the invention, sets up a conductive connection to a data store on the memory card 50, which can be used to transmit data signals.

In a second step 3, the tachograph 51 as first subscriber T1 fetches an identifier 4 from the memory card 50 as second subscriber T2 and, in a third step 5, checks whether the identifier 4 is already known from a preceding process. To this end, the tachograph 51 accesses an integrated memory 6 which stores entries whose scope is described in more detail in FIG. 3.

If the memory 6 does not contain an entry stored with the identifier 4 of the memory card 50, the inventive method moves to reciprocal security certificate verification 7. In this context, the tachograph is used during a first security certificate verification operation to checks security certificates from the memory card 50 for validity, familiarity and authenticity in line with FIG. 2, and then a corresponding second check 9 on the tachograph 51 is performed by the memory card 50.

Steps 8 and 9 are skipped if in step 5 the second subscriber T2 or the memory card 50 has been identified by the first subscriber T1 as known. If the final result of a security certificate verification operation in line with steps 8 and 9 is nonverification, the memory card 50 or the first subscriber T1 is ejected or rejected in a step 10.

In the event of successful reciprocal verification or a known identifier 4, reciprocal interchange of a random number takes place in a step 11 in RSA-encrypted form, and said random number is used in a step 12 to generate a joint session key 60 independently of the two subscribers T1, T2, said session key being used in the next step 13 for symmetrical encryption of transmitted data.

FIG. 2 shows the security certificate verification from steps 8 and 9 in FIG. 1 in detail. In a first step 21, the second subscriber T2 fetches a first-level security certificate Cert.Lev.1 from the first subscriber T1. Using entries in a memory 22, a check is performed in a second step 23 to determine whether the public key or an identifier of the firsts level security certificate Cert.Lev.1 is already known and still valid. If it is valid and known, the illustrated method moves directly to a step 24, during which the first subscriber T1 subjects the security certificate of the second subscriber T2 to a check in the same way (not illustrated separately again) If the public key of the level-1 security certificate Cert.Lev.1 has been identified as not known in step 23, the second subscriber T2 fetches from the first subscriber T1 a level-2 security certificate Cert.Lev.2 in a subsequent step 25. In line with step 23, a step 26 follows in similar fashion, during which the second subscriber T2 accesses the memory 22 in order to check the familiarity and validity of a public key of the level-2 security certificate Cert.Lev.2. If the result of the check is that the familiarity and validity are confirmed, the method moves directly to a verification step 27, during which the level-1 security certificate Cert.Lev.1 is subjected to verification. If the public key of the level-2 security certificate Cert-Lev.2 is not known and valid, the level-2 security certificate Cert.Lev.2 is first of all verified in a step 28, before the verification based on step 27 is initiated. If the checks in steps 27 and 28 result in verification of the level-1 and level-2 security certificates Cert.Lev.1, 2, the method moves to step 24, which initiates reverse security certificate verification for subscribers T1 and T2.

FIG. 3 shows the content of the memory 22 or 6 as a function of the start of communication between various second subscribers T2 and a first subscriber T1. The size of the memory 6, 22 is limited to five entries 31-35. Six successive states 41-46 are depicted in FIG. 3, which each depict the entries 31-34 after particular events. The illustrated entries 31-34 include a data item 51 whose value has been stored since Jan. 1, 1970 in hexadecimal notation as a value in seconds. In addition, the entries 31-35 include a security certificate content 52 which comprises a sequence EOV for the validity of the security certificate and a reference CHR for the security certificate holder. In addition, the entries 31-35 also include the detection time 53.

The state 41 shows the initial state, which is characterized by neutral entries.

The state 42 exists after five different second subscribers T2 or memory cards 50 have made data-transmitting contact with the subscriber T1 or tachograph 51. As a result, each entry 31-35 is now characterized by a different data item, a different security certificate content 52 and a different detection time 53.

The state 43 appears after a second subscriber originally characterized by the entry 33 has made data-transmitting contact with the first subscriber T1 again at a later time. As a result, the detection time 53 of the entry 33 has been updated.

The state 44 appears when just a number corresponding to the upper limit of entries 31-35 has been deneutralized on account of a respective connection to a second subscriber T2, and a further, previously unknown second subscriber T2 makes data-transmitting contact with the first subscriber T1. The oldest entry 31 on the basis of the detection time 53 is overwritten by a new entry 36 in line with the invention.

Similarly, the entry 32 is replaced by an entry 37 in state 45.

State 46 appears when a second subscriber T2 corresponding to the original entry 31 takes up a data-transmitting connection to the first subscriber T1 again. In this case too, the entry 34 which is now the oldest is replaced by the entry 31, which is associated with a second subscriber T2 which is unknown as a result of the overwrite from state 44.

1. A method for secure data transmission between a first subscriber and second subscribers, the first subscriber being a tachograph in a commercial vehicle and the second subscriber being memory cards having at least one respective data store, wherein the first subscriber has a memory which stores a particular number of entries each comprising identifiers and associated security certificates from second subscribers with a detection time for the security certificate, the method comprising the steps of:
fetching an identifier by the first subscriber from the second subscribers,
comparing by first subscriber the identifier with the identifiers stored in the memory,
if a matching identifier is present, prompting the security certificate associated with the identifier to be a basis for a subsequent data transmission and updating the detection time for the security certificate to a current system time, and
if no matching identifier is stored in the memory, prompting the first subscriber to perform security certificate verification with the second subscriber and, in the event of verification, storing an entry corresponding to the verified security certificate with a current detection time in the memory, with the entry with the oldest detection date being replaced by the new entry if a particular number of entries has already been reached.

2. The method according to claim 1, wherein the identifier is a public key from an RSA method from the second subscriber.

3. The method according to claim 1, wherein a subsequent data transmission is effected in TDES-encypted form, with verification of the security certificates being followed by both subscribers sending a random number in encrypted form to the other subscriber and both subscribers independently of one another each using the two random numbers to determine a common key for date transmission using the same algorithm.

4. The method according to claim 1, wherein the verification of the security certificate from the first subscriber by the second subscriber and vice versa comprises the following n number of steps:
in a first step, the second subscriber sends the first subscriber a first security certificate which the second subscriber subjects to verification using a first public key and in so doing ascertains a second public key, and
if the verification results in authenticity then the first step is repeated (n-1) times using a further transmitted security certificate and the second public key ascertained in the previous step instead of the first public key, with a new second public key and a verification result always being obtained.

5. The method according to claim 1, wherein n=3.
